(19) United States
(12) Patent Application Publication
(10) Pub. No.: US 2017/0277888 A1
(43) Pub. Date: Sep. 28, 2017

(54) SECURITY DEVICE FOR AN ELECTRONIC APPARATUS

(71) Applicant: ACCO Brands Corporation, Lake Zurich, IL (US)

(72) Inventors: Todd C. Robinson, Belmont, CA (US); Alex J. Klinkman, Oakland, CA (US)

(21) Appl. No.: 15/505,501

(22) PCT Filed: Aug. 21, 2015
(86) PCT No.: PCT/US2015/046232

§ 371 Date: Feb. 21, 2017

Related U.S. Application Data
(60) Provisional application No. 62/041,333, filed on Aug. 25, 2014.

(51) Int. Cl. G06F 21/55; G06F 21/86; G06F 21/88

(52) U.S. Cl. CPC G06F 21/554; G06F 21/88; G06F 21/86

(57) ABSTRACT

A security device for an electronic apparatus having a port includes a housing and a connector extending from the housing. The connector is configured to couple to the port of the electronic apparatus. The security device also includes a sensor supported by the housing and operable to generate an output in response to an event detected by the sensor, and a wireless communication module supported by the housing and electrically coupled to the sensor. The wireless communication module is operable to transmit a wireless message to a remote device based on the output from the sensor.

### RELATED APPLICATIONS

This application claims priority to U.S. Provisional Patent Application No. 62/041,333, filed Aug. 25, 2014, the entire contents of which are incorporated by reference herein.

### BACKGROUND

The present invention relates to remote monitoring systems, and, in particular, to systems for remote monitoring of electronic devices.

As a person or organization owns more electronic devices, managing the electronic devices becomes an important task. For example, a school having a cabinet or cart with tablet computers also has to ensure that all the tablet computers are returned, that the tablet computers are charged so they can be used when needed, and, especially, that the tablet computers are not stolen. However, physically guarding an electronic device, or multiple electronic devices, may sometimes be impractical.

### SUMMARY

In one embodiment, the invention provides a security device for an electronic apparatus having a port. The security device includes a housing and a connector extending from the housing. The connector is configured to couple to the port of the electronic apparatus. The security device also includes a sensor supported by the housing and operable to generate an output in response to an event detected by the sensor, and a wireless communication module supported by the housing and electrically coupled to the sensor. The wireless communication module is operable to transmit a wireless message to a remote device based on the output from the sensor.

In another embodiment, the invention provides a method of monitoring an electronic apparatus with a removable security device. The security device includes a housing, a connector extending from the housing, a sensor supported by the housing, and a wireless communication module supported by the housing and electrically coupled to the sensor. The method includes coupling the connector of the security device to a port of the electronic apparatus, and detecting, by the sensor, an event indicative of a state of the electronic apparatus. The method also includes generating, by the sensor, an output in response to the detected event, and transmitting, by the wireless communication module, a wireless message to a remote device based on the output from the sensor.

Other aspects of the invention will become apparent by consideration of the detailed description and accompanying drawings.

### BRIEF DESCRIPTION OF THE DRAWINGS

FIG. 1 illustrates a security system according to one embodiment of the invention.

FIG. 2 illustrates examples of various electronic apparatuses for use with the security system shown in FIG. 1.

FIG. 3 is a schematic diagram of one of the electronic apparatuses.

FIGS. 4A-C include various views of a security device of the security system of FIG. 1.

FIG. 5 is a schematic diagram of the security device of FIGS. 4A-C.

FIG. 6 is a flowchart depicting operation of the security system of FIG. 1.

FIG. 7 is a schematic diagram of a monitoring system of the security system of FIG. 1.

FIG. 8 is a schematic diagram of a mobile communication device of the security system of FIG. 1.

FIGS. 9A-B illustrate operation of the security system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

It should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible. The terms “processor,” “central processing unit,” and “CPU” are interchangeable unless otherwise stated. Where the terms “processor,” or “central processing unit,” or “CPU” are used as identifying a unit performing specific functions, it should be understood that, unless otherwise stated, those functions can be carried out by a single processor, or multiple processors arranged in any form, including parallel processors, serial processors, tandem processors or cloud processing/cloud computing configurations.

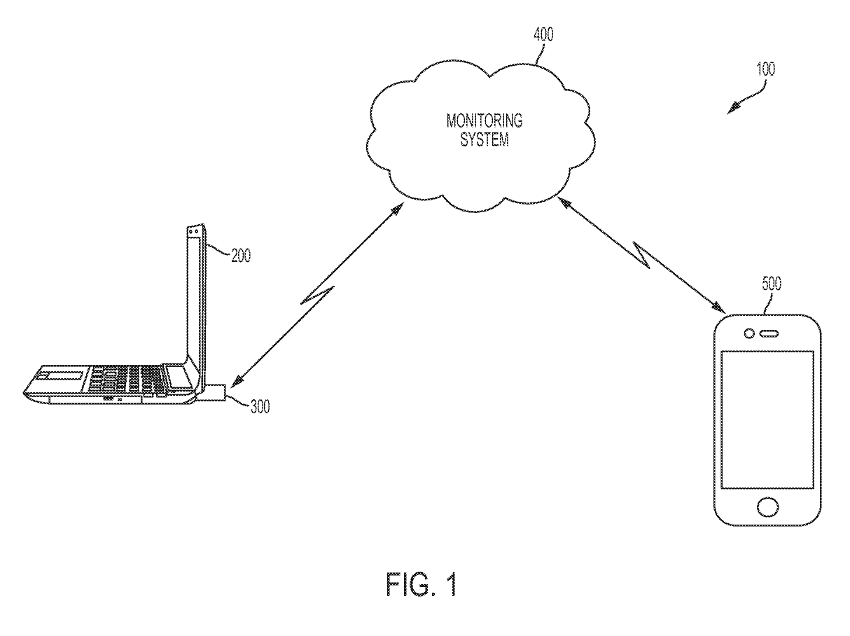

FIG. 1 illustrates a security system 100 that includes an electronic apparatus 200, a security device 300, a monitoring system 400, and a mobile communication device 500. The security system 100 allows remote monitoring of the electronic apparatus 200 by connecting the security device 300 to the electronic apparatus 200. The security device 300 is a relatively small, unobtrusive object that plugs into an existing port of the electronic apparatus 200. When the security device 300 detects an event associated with the electronic apparatus 200, the security device 300 communicates with the monitoring system 400, which in turn alerts a user through the mobile communication device 500. The user may then respond to the alert appropriately and timely.

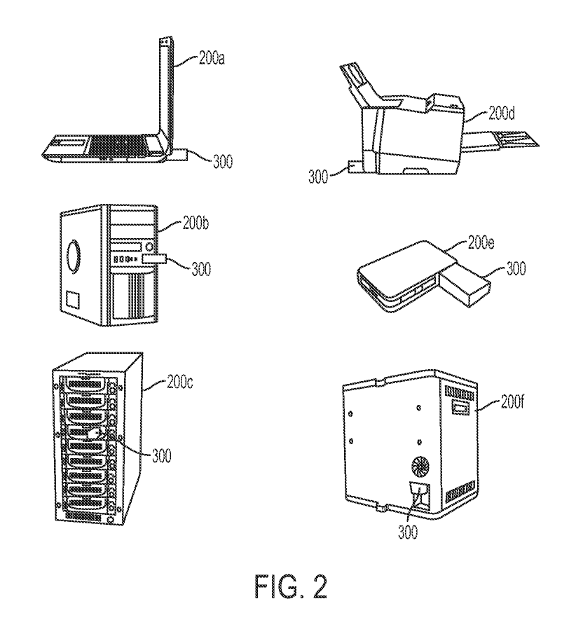

As shown in FIG. 2, the electronic apparatus 200 may be any electronic apparatus that includes a port suitable for connecting to the security device 300. The electronic apparatus 200 may be, for example, a laptop computer 200a, a tablet computer, a desktop computer 200b, a server or server system 200c, an electronic peripheral device 200d (e.g., a printer, a scanner, a CD reader/writer, a music player, and the like), a port replicator 200e, a smartphone, a cellphone, a two-way radio, a charger, and the like. In some embodiments, the electronic apparatus 200 may be an IPAD tablet computer sold by Apple, Inc. In other embodiments, the electronic apparatus 200 may be a cabinet 200f to store and/or charge a plurality of tablet computers.

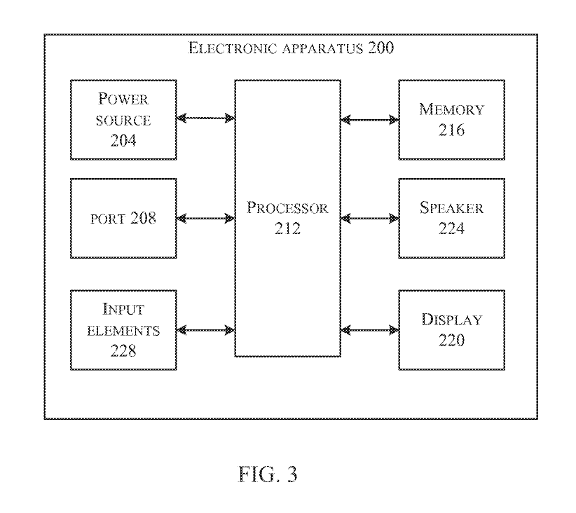

As shown in FIG. 3, in the illustrated embodiment, the electronic apparatus 200 includes a power source 204 to power different elements and components of the electronic apparatus 200. In some embodiments, the power source 204 may include a battery or a plurality of batteries or battery packs. In other embodiments, the power source 204 may include a power adapter and a power connector. The power connector connects to an external power source (e.g., a wall outlet). The power adapter conditions the power received from the external power source to provide the appropriate amount of power to the electronic apparatus 200. For example, the power adapter may condition 120V from a wall outlet to 5V needed to charge and/or power the electronic apparatus 200. In yet other embodiments, the power source 204 may include a rechargeable battery, a charging circuit, and a power connector to connect to an external power source to charge the rechargeable battery.

The electronic apparatus 200 also includes a port 208 for electrically connecting to other electronic devices. In some embodiments, the port 208 may be coupled to the power source 204 to provide at least a portion of the power to an electronic device connected to the port 208. Additionally or alternatively, the port 208 may be configured to communicate data between the electronic apparatus 200 and another electronic device connected to the electronic apparatus 200. The protocol used by the port 208 to communicate data, however, can be different depending on, among other things, the type of electronic device to which the electronic apparatus 200 is coupled. For example, the port 208 may communicate data using serial communication, TCP/IP protocol, BLUETOOTH, and the like. In the illustrated embodiment, the port 208 is a universal serial bus port (USB) port that can transfer both power and data between the electronic apparatus 200 and the coupled electronic device. The USB port 208 may be a type A USB port, a type B USB port, a type C USB port, or another USB port based on the functionality of the electronic apparatus 200 and the security device 300. The illustrated port 208 is configured to connect to the security device 300 for remote monitoring of the electronic apparatus 200.

In some embodiments, the electronic apparatus 200 may also include other components such as, for example, a processor 212, a memory 216, a display 220, a speaker 224, and input elements 228 (e.g., buttons, a touchscreen, dials, etc.). These other components may allow a user to control operation of the electronic apparatus 200 (e.g., a power button controls when the electronic apparatus 200 is on). In addition, these components may provide indication to the user regarding the operation and/or state of the electronic apparatus 200 (e.g., an LED may indicate that the electronic apparatus 200 is communicating with a remote device such as the monitoring system 400).

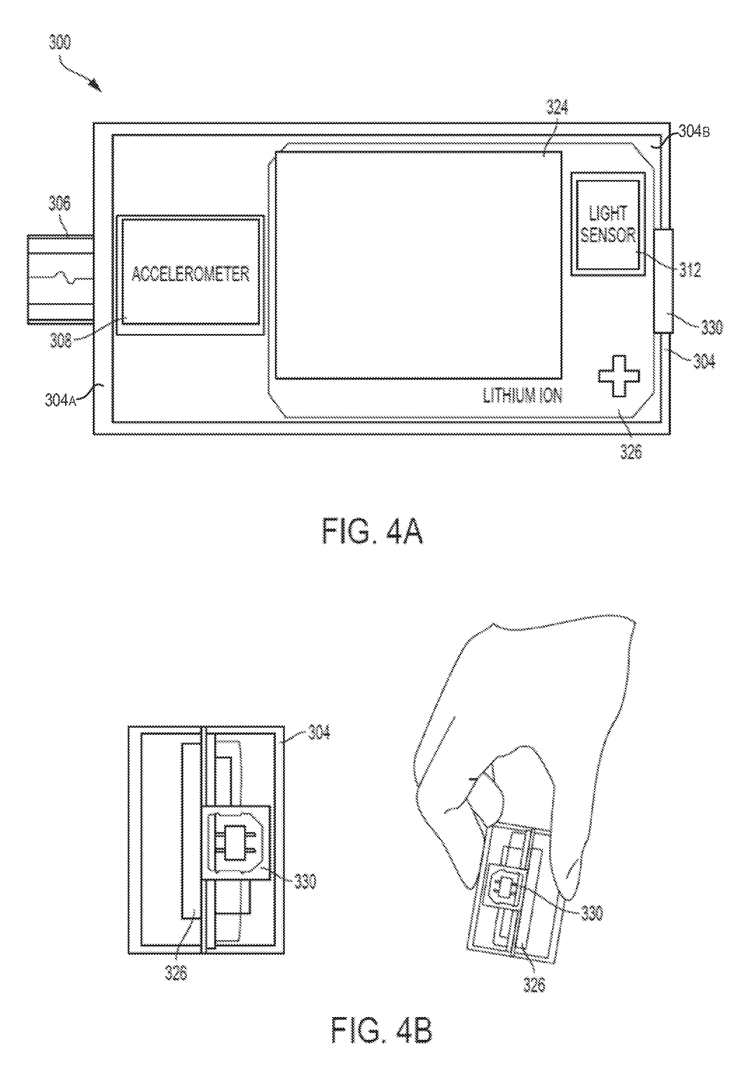

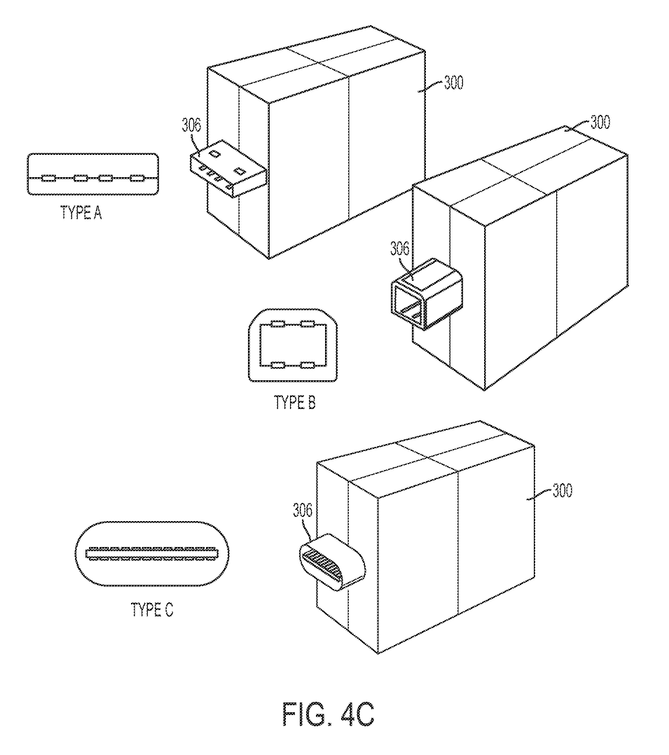

A user may want to protect or monitor the electronic apparatus 200 for various reasons. For example, the electronic apparatus 200 may contain sensitive and/or confidential information, the electronic apparatus 200 may have been a costly investment, or the electronic apparatus 200 may be used regularly and provides convenience to the user. In order to protect and/or monitor the electronic apparatus 200, the security device 300 is coupled to the electronic apparatus at the port 208. As shown in FIG. 4A, the security device 300 includes a tamper-resistant housing 304. In some embodiments, the tamper-resistant housing 304 may be made from a single plastic overmold, such that any attempt to remove the housing 304 results in destruction of the security device 300. In other embodiments, the tamper-resistant housing 304 may be composed of two or more portions coupled together with, for example, screws requiring a special removal tool. The tamper-resistant housing 304 provides protection to the security device 300 against unauthorized people.

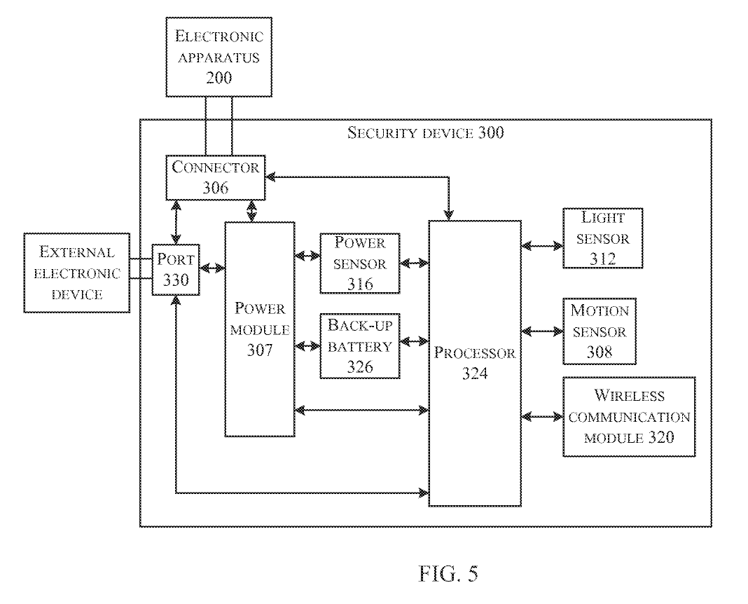

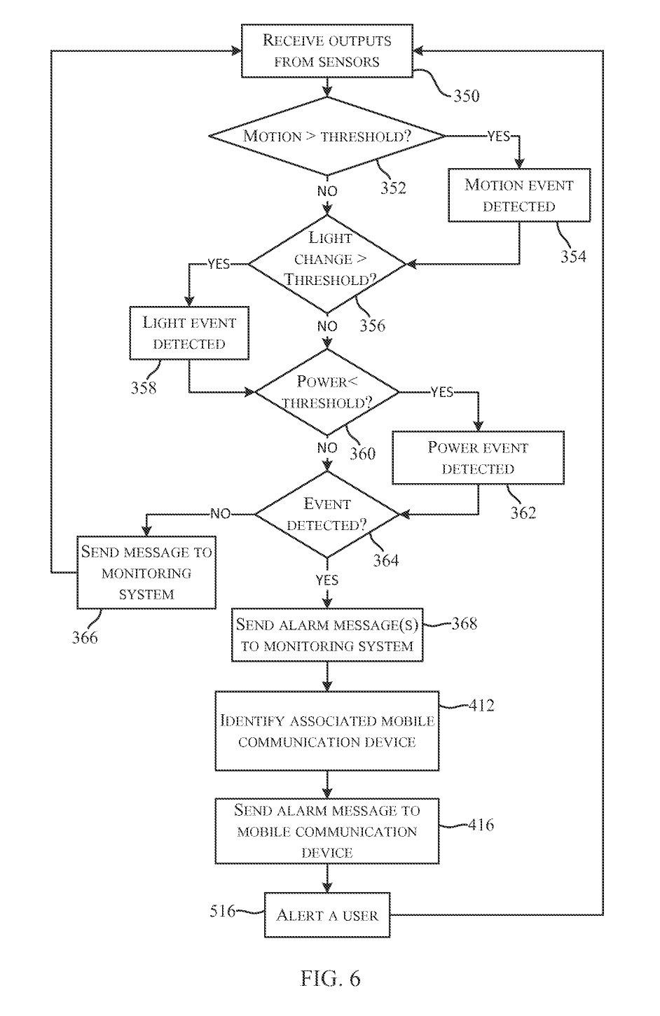

As shown in FIGS. 4A-5, the security device 300 includes a connector 306 for connecting to the port 208 of the electronic apparatus 200, a power module 307, a motion sensor 308 that detects changes in movement of the security device 300, a light sensor 312 that detects changes in ambient light conditions, a power sensor 316 that detects power received from the electronic apparatus 200 through the port 208, a wireless communication module 320 (FIG. 5), and a processor 324. The connector 306 connects to the port 208 to releasably secure the security device 300 to the electronic apparatus 200 so that the security device 300 moves with the electronic apparatus 200 (if the electronic apparatus 200 is moved). The connector 306 also connects to the port 208 to receive power from the electronic apparatus 200. In some embodiments, the connector 306 is also configured to exchange (e.g., send or receive) data with the electronic apparatus 200. In the illustrated embodiment, the connector 306 is a universal serial bus port (USB) connector that can transfer both power and data between the electronic apparatus 200 and the security device 300. As shown in FIG. 4A, the connector 306 is positioned on a proximal end 200a of the housing 304. The proximal end 200a of the housing 304 is closer to the electronic apparatus 200 than a distal end 200b of the housing 304. The distal end 200b, in contrast, is further away from the electronic apparatus 200. In particular, the connector 306 is configured to connect to the electronic apparatus 200 to enable remote monitoring of the electronic apparatus 200. Similar to the port 208, the USB connector 306 may be a type A USB port, a type B USB port, a type C USB port, or another USB port based on type of port 208 available on the electronic apparatus 200 (see FIG. 4C).

As shown in FIG. 5, the power module 307 is coupled to the connector 306, the processor 324, and the power sensor 316. The power module 307 is a combination of hardware and software that receives power from the electronic apparatus 200 through the connector 306 and conditions the power such that the processor 324 receives voltage and current according to specifications particular to the processor 324. The power module 307 may include a step-down voltage converter, a power filter, a switching network, and the like.

Each sensor 308, 312, 316 provides information to the processor 324 regarding a condition or event associated with the security device 300. The processor 324 uses the information received through the sensors 308, 312, 316 to determine whether the electronic apparatus 200 is being compromised. When the processor 324 determines that the electronic apparatus 200 is being compromised based on the output from one of the sensors 308, 312, 316, the wireless communication module 320 sends a wireless message to a remote device to alert the user of the situation. The illustrated security device 300 includes three different sensors 308, 312, 316 to detect different types of events, as explained below. In other embodiments, the security device 300 may only include a single sensor, or may include any combination of two of the three sensors discussed below. In further embodiments, the security device 300 may include other types of sensors to detect different types of events associated with unauthorized access to an electronic apparatus (e.g., stealing the electronic apparatus). For example, in some embodiments, the security device 300 may alternatively or additionally include an IR sensor to detect the heat from a human subject (e.g., a thief).

For the processor 324 to determine when the electronic apparatus 200 is being compromised, each sensor 308, 312, 316 generates an output corresponding to a detected event associated with the security device 300. The motion sensor 308 is coupled to the processor 324 and detects changes in movement of the security device 300. In the illustrated embodiment, the motion sensor 308 includes a three-axis accelerometer. In other embodiments, different types of motion sensors can be used in addition to or instead of the three-axis accelerometer. For example, in some embodiments, the motion sensor 308 can include a gyroscope, a GPS module, and the like. The motion sensor 308 is operable to detect a motion event based on the movement (i.e., change of position) of the security device 300. In some embodiments, the motion sensor 308 detects the motion event only when the security device 300 changes geographical location by a particular threshold or when the security device 300 moves faster than a particular speed threshold. In other embodiments, however, the sensitivity of the motion sensor 308 is higher and the motion sensor 308 detects the motion event when the security device 300 is slightly tilted or bumped, without necessarily changing the location or speed of the security device 300. In the illustrated embodiment, the motion sensor 308 is positioned in the proximal end 200a of the security device 300 (e.g., adjacent the same end of the housing 304 as the connector 306). In other words, the motion sensor 308 is closer to the proximal end 200a of the security device 300 than to the distal end 200b of the security device 300. By positioning the motion sensor 308 closer to the electronic apparatus 200, the movement detected by the motion sensor 308 is more closely indicative of movement of the electronic apparatus 200. In other embodiments, the motion sensor 308 may be positioned elsewhere on the security device 300.

The light sensor 312 is also coupled to the processor 324 and is operable to detect a light event based on changing ambient light conditions surrounding the security device 300. The light sensor 312 may include, for example, a photoresistor, a photodiode, phototransistors, and the like. Often when an object (e.g., the electronic apparatus 200) is moved or tampered with, the ambient light conditions change. For example, if the electronic apparatus 200 is stored in a dark room and someone tries to move the electronic apparatus 200, the user may use a flashlight or turn on an overhead light to disconnect the electronic apparatus 200 from a wall outlet, causing a change (e.g., from dark to bright) in ambient light conditions. In other situations, a thief may block light from a window or a lamp, thereby causing a change (e.g., from bright to dark) in ambient light conditions. Therefore, the detection of the light event may be indicative of tampering of the electronic apparatus 200. As with the motion sensor 308, the sensitivity of the light sensor 312 may change based on the specific application.

As shown in FIG. 4A, the light sensor 312 is positioned adjacent the distal end 200b of the housing 304 (i.e., the light sensor 312 is closer to the distal end 200b than to the proximal end 200a of the housing). That is, the light sensor 312 is positioned farther away from the electronic apparatus 200 to have better reception for ambient light changes. The farther the light sensor 312 is away from the electronic apparatus 200, the more ambient light the light sensor 312 is able to receive. Accordingly, the motion sensor 308 and the light sensor 312 are positioned opposite one another, and in opposite sides of the housing 304.

In some embodiments, the light sensor 312 is also used to configure programming of the security device 300. For example, the light sensor 312 may receive configuration commands from an external device (e.g., a programming tool) through optical communication (e.g., IR) to program the security device 300. This programming of the security device 300 may be done at time of manufacture and/or may be done by a user to change at least some of the settings associated with the security device 300.

As shown in FIG. 5, the power sensor 316 is coupled to the power module 307 and the processor 324. The power sensor 316 detects a power event in response to, for example, the security device 300 no longer receiving power from the electronic apparatus 200 through the connector 306. The power event may be indicative of when the security device 300 is disconnected from the electronic apparatus 200 (intentionally or unintentionally) and, therefore, ceases to receive power from the electronic apparatus 200. The power event may also or alternatively be indicative of when the security device 300 remains connected to the electronic apparatus 200, but the electronic apparatus 200 is disconnected from an external power source, thus inhibiting or reducing transmission of power to the security device 300. In some embodiments, the power sensor 316 includes a voltage detector, such as a voltage divider network or an amplifier. In other embodiments, the power sensor 316 includes a current detector, such as, for example, a Hall Effect sensor. In yet other embodiments, the power sensor 316 may include a combination of both a voltage detector and a current detector. In some embodiments, the power sensor 316 is not a separate component, but rather is part of another component of the security device. For example, the power sensor 316 may be integrated into the power module 307 since the power module 307 already conditions the power received through the connector 306 and transmits the power to the processor 324.

When one of the sensors 308, 312, 316 detects an event (e.g., a light event, a motion event, and/or a power event), the sensor 308, 312, 316 generates an output that indicates an event has been detected. For example, the light sensor 312 may generate an output of zero volts when little or no ambient light is detected and may generate an output of, for example, 1.5 volts when bright ambient light is detected. The output from each sensor 308, 312, 316 may be analog or digital. The sensor 308, 312, 316 sends the output to the processor 324 for processing.

In some embodiments, a user may configure the sensitivity of each sensor 308, 312, 316 according to his/her preference and/or specific situation. For example, the user may want the motion sensor 308 to operate with high sensitivity such that most movements of the security device 300 are detected by the motion sensor 308, but may prefer that the light sensor 312 only detects significant changes in light conditions.

The processor 324 is coupled to each sensor 308, 312, 316, the port 330, the battery 326, and the wireless communication module 320. The processor 324 is operable to receive the outputs from each sensor 308, 312, 316 and determine whether an event has been detected by the sensors 308, 312, 316 based on the received outputs.

Upon the detection of an event by any of the sensors 308, 312, 316, the processor 324 controls the wireless communication module 320 to transmit a wireless message to the monitoring system 400. The wireless communication module 320 includes a wireless transceiver configured to receive and transmit wireless messages from remote devices. The wireless communication module 320 may transmit and receive wireless messages using different communication protocols. For example, the wireless communication module 320 may communicate using TCP/IP protocol, BLUETOOTH protocol, or a combination of protocols compatible with broadband communications, cellular communications, short-range communications (e.g., BLUETOOTH, Near Field Communications, ZIGBEE, etc.). In some embodiments, the wireless communication module 320 also includes a translator that allows the wireless communication module 320 to translate wireless messages from one protocol to another so that the security device 300 may transmit wireless messages to more than one type of remote device (e.g., a smartphone and a laptop computer). In the illustrated embodiment, the wireless communication module 320 transmits the wireless message using TCP/IP protocol through a network (e.g., the Internet) connecting the security device 300 with the remote device. The wireless communication module 320 also includes an antenna for receiving and transmitting the wireless messages. In the illustrated embodiment, the wireless communication module 320 is coupled to and controlled by the processor 324. The processor 324 generates the wireless message to be transmitted, and the wireless communication module 320 transmits the wireless message as requested by the processor 324.

As shown in FIGS. 4A-B and 5, the security device 300 also includes an input port 330 to allow communication with the electronic apparatus 200. The input port 330 is coupled to the connector 306 such that if another electronic device (e.g., a second electronic apparatus 200) is connected to the input port 330, power and/or data can be exchanged with the electronic apparatus 200 through the input port 330, the connector 306, and the port 208. The input port 330 is also connected to the power module 307 such that conditioned power can be distributed by the input port 330 to an external electronic device. The input port 330 allows several electronic devices to be connected to each other in a daisy chain manner to receive power from a single wall outlet and/or to sync data between the electronic devices, without removing the security device 300 from the port 208 of the electronic apparatus 200. In the illustrated embodiment, the input port 330 is a USB port, although other types of communication ports can also be used. Similar to the port 208 and the connector 306, the input port 330 may be a type A USB port, a type B USB port, a type C USB port, or another type of USB port based on the type of USB connector corresponding to the connector 306.

In the illustrated embodiment, the security device 300 also includes a battery 326. In some embodiments, the battery 326 provides power to the other components of the security device 300 when the electronic apparatus 200 ceases to provide power to the security device 300 (e.g., when the power event is detected). In other embodiments, the battery 326 constantly provides power to the other components of the security device 300. The battery 326 allows the wireless communication module 320 and the processor 324 to continue operation even after power is not provided by the electronic apparatus 200, such that the user is alerted of the detected events. In some embodiments, the battery 326 is a rechargeable battery. In such embodiments, the security device 300 may also include a charging circuit to control charging of the rechargeable battery. In the illustrated embodiment, the battery 326 is also coupled to the power module 307 to receive power and charge while the security device 300 is connected to (e.g., plugged into) the electronic apparatus 200. In other embodiments, the battery 326 may be a replaceable battery. In such embodiments, the security device 300 may also include an accessible compartment on the housing 304 to store the replaceable battery, such that a user can remove and insert batteries when necessary.

FIG. 6 illustrates operation of the security device 300, which is generally implemented by the processor 324. First in step 350, the processor 324 receives the outputs from the sensors 308, 312, 316. The processor 324 then proceeds to determine whether the output from the motion sensor 308 indicates that movement change of the security device exceeds (i.e., is above, is greater than or equal to) a motion threshold (step 352). If the processor 324 determines that the motion detected by the motion sensor 308 exceeds the motion threshold, the processor 324 determines that a motion event is detected (step 354). If, however, the processor 324 determines that the motion detected by the motion sensor 308 is below the motion threshold, the processor 324 continues to analyze the output from the light sensor 312 (step 356).

At step 356, the processor 324 determines whether the output from the light sensor 312 indicates that a change in ambient light exceeds (i.e., is above, is greater than or equal to) a light change threshold. In the illustrated embodiment, the light change threshold only considers the magnitude of the light change, not the direction in which the ambient light changed. For example, a increase in ambient brightness and a decrease in ambient brightness may each exceed the light change threshold if the magnitude of the ambient light change is greater than the light change threshold. If the processor 324 determines that the light change detected by the light sensor 312 exceeds the light change threshold, the processor 324 determines that a light event is detected (step 358). If, on the other hand, the processor 324 determines that the light change detected by the light sensor 312 is below the light change threshold, the processor 324 proceeds to analyze the output from the power sensor 316 (step 360).

At step 360, the processor 324 determines whether the output from the power sensor 316 indicates that the power received from the connector 306 is below (i.e., less than or equal to, does not exceed) a power threshold. If the processor 324 determines that the power detected by the power sensor 316 is below the power threshold, the processor 324 determines that a power event is detected (step 362). If, however, the processor 324 determines that the power detected by the power sensor 316 is above the power threshold, the processor 324 proceeds step 364.

In embodiments where the security device 200 does not include all three sensors 308, 312, 316, one or more of the steps 352, 356, 360 may be omitted from the flowchart of FIG. 6. For example, if the security device 300 does not include the power sensor 316, step 360 may be omitted such that operation of the security device 300 proceeds from step 356 (or step 358) to step 364.

At step 364, the processor 324 determines if any events were detected (e.g., a light event, a power event, or a motion event). If the processor 324 determines that no events were detected, the processor 324 continues to receive and analyze the output signals from the sensors 308, 312, 316. In the illustrated embodiment, the processor 324 also optionally directs the wireless communication module 320 to transmit a message to the monitoring system 400 indicating that no event has been detected and that the electronic apparatus 200 is not currently at risk (step 366). As long as the processor 324 continues to determine that no events are detected, the wireless communication module 320 can optionally periodically transmit messages to the monitoring system 400 indicating that no events are detected. If, on the other hand, the processor 324 determines that an event is detected (e.g., a light event, a motion event, and/or a power event), the processor 324 controls the wireless communication module 320 to transmit an alarm message to the monitoring system 400 (step 368). In some embodiments, the security device 300 does not send periodic messages to the monitoring system 400 when no events are detected. Rather, in such embodiments, the security device 300 only communicates with the monitoring system when an event is detected by the sensors 308, 312, 316. Sending messages to the monitoring system 400 only when an event is detected may decrease the power consumption of the security device.

In the illustrated embodiment, the wireless communication module 320 sends an alarm message per event detected by the processor 324. For example, if the processor 324 determines that both a light event and a motion event are detected, the wireless communication module 320 transmits a first alarm message regarding the detected light event and a second alarm message regarding the detected motion event to the monitoring system 400. In other embodiments, the wireless communication module 320 sends a single alarm message indicating which events were detected by the security device 300. In some embodiments, the security device 300 only sends an alarm message when more than one event is detected by the sensors 308, 312, 316. For example, the security device 300 may send an alarm message to the monitoring system 400 when the motion sensor 308 and the light sensor 312 both detect an event. Additionally, or alternatively, the processor 324 assigns different priorities to the events detected by the sensors 308, 312, 316. For example, the processor 324 may receive a signal from the light sensor 312 indicating that a light event was detected, and may send an alarm message to the monitoring system 400 only after confirmation from the motion sensor 308 that a motion event was also detected. However, the processor 324 may send the alarm message to the monitoring system 400 if the power sensor 316 indicates that a power event was detected without waiting for confirmation from another sensor 308, 312. Assigning different priorities and assessing the outputs received from the sensors 308, 312, 316 helps decrease the potential for false alarm messages being sent to the monitoring system 400.

In the illustrated embodiment, the alarm message indicates which event(s) were detected by the security device 300. For example, the alarm message may indicate which sensor 308, 312, 316 detected an event, the type of event detected, the date and time when the sensor 308, 312, 316 detected the event, and other relevant information. The alarm message may also include identification information for the security device 300 and/or the electronic apparatus 200 connected to the security device 300. The identification information may include, for example, serial numbers, names of users associated with the security device 300 and/or the electronic apparatus 200, numbers related to the mobile communication device 500 associated with the security device 300, and the like.

Using the alarm message (e.g., the identification information included in the alarm message), the monitoring system 400 identifies a mobile communication device 500 associated with the security device 300 (step 412), and sends the alarm message to the associated mobile communication device 500 (step 416). The associated mobile communication device 500 then alerts the user that an event related to the security device 300 was detected (step 516).

Although the steps in FIG. 6 are shown as occurring serially, in some embodiments one or more of the steps may be executed simultaneously (i.e., in parallel). For example, the processor 324 may simultaneously check if any of the sensor outputs indicate an event has been detected by the sensors 308, 312, 316, rather than checking the sensor outputs in series as shown in FIG. 6. If one of the sensors 308, 312, 316 has detected an event, the processor 324 may then send an alarm message without determining whether the other sensors have also detected an event. Simultaneous or parallel operation may increase efficiency and/or speed of the security device 300.

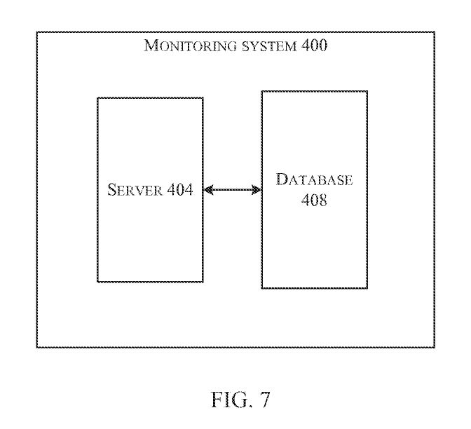

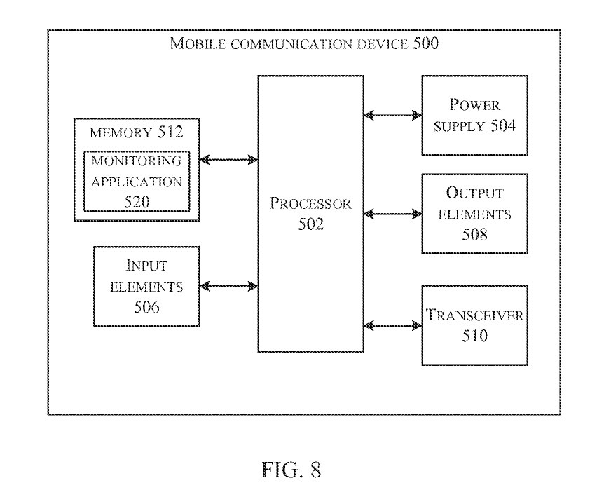

The monitoring system 400 receives the alarm message from the security device 300, determines where to route the alarm message, and routes the alarm message to the appropriate mobile communication device 500. As shown in FIG. 7, the monitoring system 400 includes a server 404 and a database 408. The server 404 is configured to receive the messages from the security device 300 and transmit alarm messages to the mobile communication device 500. The server 404 communicates with the database 408. The database 408 stores information regarding different security devices 300 and associates each security device 300 and/or each electronic apparatus 200 with a corresponding mobile communication device 500. The database 408 may utilize identification information included in the wireless message to determine which mobile communication device 500 is associated with the particular security device 300. The server 404, upon receiving the wireless message from the security device 300, accesses the database 408 to determine which mobile communication device 500 is associated with the security device 300 (step 412 in FIG. 6). If the wireless message received by the monitoring system 400 is an alarm message, the monitoring system proceeds to forward the alarm message to the mobile communication device 500 associated with the security device 300 (step 416 in FIG. 6). The mobile communication device 500 may alert the user by generating light, sound, or vibration signals. If the wireless message received from the security device 300 is not an alarm message, the monitoring system 400 may store the wireless message or simply ignore the message.

The mobile communication device 500 associated with the security device 300 then receives the alarm message from the monitoring system 400 and alerts a user that the security device 300 has detected an event associated with the electronic apparatus 200. The mobile communication device 500 can be, for example, a smartphone, a tablet computer, a laptop computer, a cellular phone, or any other electronic device capable of sending and receiving wireless messages to and from the monitoring system 400. In the illustrated embodiment, the mobile communication device 500 is a smartphone.

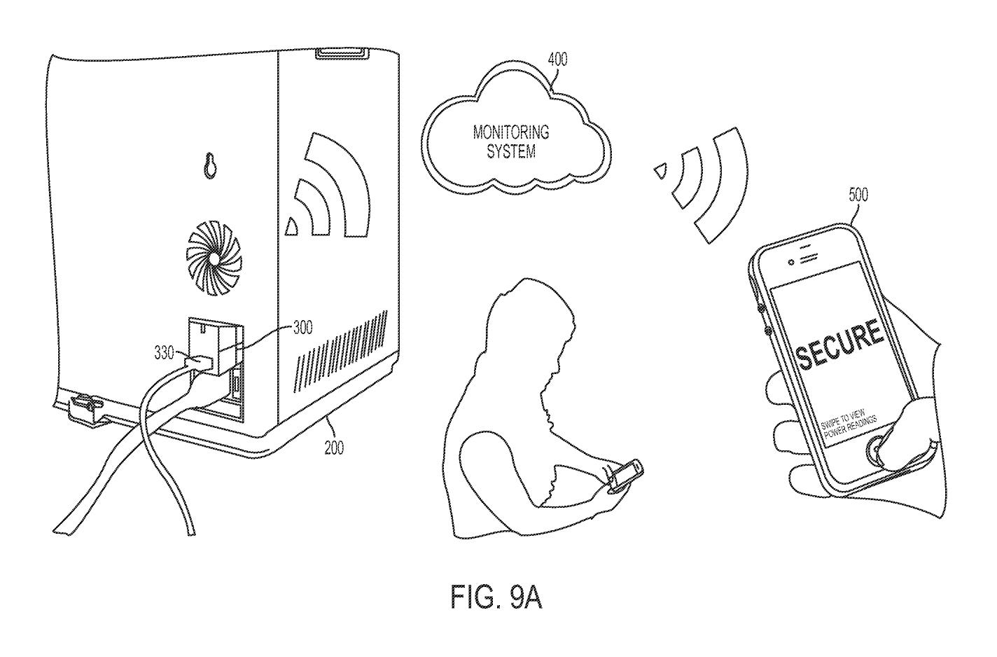

As shown in FIG. 8, the mobile communication device 500 includes a processor 502, a power supply 504, input elements 506, output elements 508, a transceiver 510, and a memory 512. The transceiver 510 is used to receive wireless messages from the monitoring system 400. In the illustrated embodiment, the transceiver 510 communicates with monitoring system 400 through a network such as, for example, the Internet. In some embodiments, the transceiver 510 is configured to receive wireless messages from the security device 300 directly, without sending the wireless messages to the monitoring system 400. In such embodiments, the security device 300 and/or the mobile communication device 500 are configured and programmed to communicate directly with each other. The power supply 504 provides power to the components of the mobile communication device 500, such as, for example, the input elements 506, the output elements 508, the transceiver 510, and the processor 502. The power supply 504 may also provide power to other components of the mobile communication device 500 and may also provide power, through a port, to an external electronic device. The input elements 506 allow a user to interact with the mobile communication device 500 and control operation of the mobile communication device 500. The input elements 506 can include buttons, switches, sensors (e.g., a touchscreen), digital buttons, a microphone, and the like. A user may utilize the input elements 506 to, for example, provide identification information to the monitoring system 400 such that the mobile communication device 500 is associated with a particular security device 300.

The output elements 508 allow the mobile communication device 500 to communicate with the user. The output elements 508 can include, for example, a display, speakers, a vibrating element, an indicator (e.g., an LED), and the like. When the mobile communication device 500 receives the alarm message from the monitoring system 400, the mobile communication device 500 uses the output elements 508 to alert the user (step 516 in FIG. 6). The mobile communication device 500 may use one or more output elements 508 to alert the user. For example, the mobile communication device 500 may generate a sound, vibrate, display an image or icon on the display, or light up the indicator to alert the user that an alarm message has been received.

The memory 512 of the mobile communication device 500 includes a non-transitory computer-readable medium storing data and instructions used by the processor 502. In the illustrated embodiment, the memory 512 stores a monitoring application 520 associated with the security device 300 and the monitoring system 400. In some embodiments, the monitoring application 520 is stored and executed directly on the mobile communication device 500. In such embodiments, the monitoring system 400 may be omitted and the wireless messages from the security device 300 are sent directly to the mobile communication device 500. In other embodiments, the mobile communication device 500 connects to the monitoring system 400 to access and interact with the monitoring application 520 (e.g., the monitoring system 400 hosts the monitoring application 520). In yet other embodiments, some aspects of the monitoring application 520 are hosted by the mobile communication device 500 and other aspects of the monitoring application 520 are hosted by the monitoring system 400.

The processor 502 is coupled to the power supply 504, the input elements 506, the output elements 508, the transceiver 510, and the memory 512. The processor 502 receives the alarm message from the transceiver 510 and controls the output elements 508 to generate an alert to the user. The monitoring application 520 allows the user to manage the security device 300 and the communication between the monitoring system 400 and the mobile communication device 500. In some embodiments, the security system 100 may include multiple security devices 300. In such embodiments the monitoring application 520 allows the user to manage the communication regarding each security device 300. For example, the monitoring application 520 may indicate to the user which particular security device 300 is connected to which electronic apparatus 200 and/or provide a status for each security device 300 upon request. The monitoring application 520 may also provide information regarding the geographical location of the security device 300. For example, if the security device 300 is connected to a charge and sync cabinet located at a school, the monitoring application 520 indicates to the user that the security device 300 and electronic apparatus 200 are at the school.

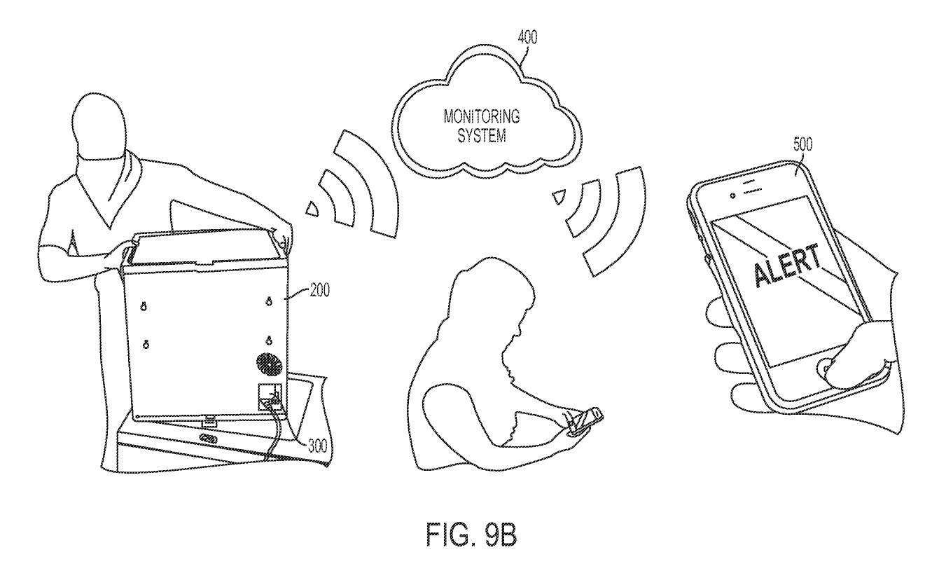

The monitoring application 520 also allows the user to control the activation and deactivation of the security device 300. For example, if a user is next to the security device 300, the security device 300 and/or monitoring system 400 may not need to communicate with the mobile communication device 500 as any unusual event would be detected by the user first. Therefore, to prevent unnecessary monitoring of the security device 300, in the illustrated embodiment the application 520 requires the user to actively prompt the security device 300 to start remote monitoring of the electronic apparatus 200. Otherwise, the monitoring application 520 remains unarmed and does not monitor the electronic apparatus 200. As shown in FIG. 9A, the user activates remote monitoring by identifying the security system 100 as “secure” by using the monitoring application 520 on the mobile communication device 500. To enable remote monitoring of the security device 300, the user may, for example, actuate a button on the mobile communication device 500 or press a button on the security device 300. Once the security system 100 is activated, the security device 300, the mobile communication device 500, and the monitoring system 400 communicate regarding the security device 300.

In some embodiments, the monitoring application 520 provides a list of security devices 300 to be activated or deactivated. The user selects a particular security device and activates the selected security device. In some embodiments, the monitoring application 520 displays a list of the electronic apparatuses 200 being monitored rather than the security device 300 associated with the electronic apparatus 200. Displaying the electronic apparatus 200 may provide a better indication of the use of the security device 300 than a list of the security devices 300. By selecting a particular security device 300 or electronic apparatus 200 from the displayed list, the user can also change the associated electronic apparatus 200 or security device, respectively. Therefore, in some embodiments, the monitoring application 520 allows the user to change settings of the security device 300. The monitoring application 520 communicates these changes to the security device 300 through the monitoring system 400, for example. In other embodiments, the monitoring application 520 may communicate with the security device 300 directly when changing setting and/or parameters associated with the security device 300.

The monitoring application 520 may indicate to the user the status of each security device 300 (e.g., whether an event has been detected at any security device 300). If an event has been detected, the monitoring application 520 may store information regarding the event for future accessibility. The monitoring application 520 indicates what event, if any, has been detected at which security device connected to which electronic apparatus 200. In some embodiments, the monitoring application 520 also allows a user to specify how the mobile communication device 500 alerts the user. For example, the monitoring application 520 may include a notifications block that allows the user to specify that if a particular event is detected at the security device 300, the mobile communication device 500 plays a particular sound and lights up the indicator. The mobile communication device 500 alerts the user in the particularly specified manner. The mobile communication device 500 may alert the user with an SMS message, an e-mail, a notification through the monitoring application 520, a phone call, and the like. Thus, the monitoring application 520 allows the mobile communication device 500 to receive information regarding the security device 300 and control settings regarding the communication between the monitoring system 400 and the mobile communication device 500. For example, FIG. 9B illustrates a user receiving an alert through the mobile communication device 500 regarding a detected event by a security device 300.

In some embodiments, the monitoring application 520 may also allow the user to change the sensitivity or each sensor 308, 312, 316 or of the security device 300 in general. The monitoring application 520 may present predefined levels of sensitivity selectable by a user, or the monitoring application 520 may provide a mechanism for more customized determination of the sensitivity of the sensors 308, 312, 316. For example, the monitoring application 520 may include slide bars that allow a user to change the sensitivity of each sensor 308, 312, 316. In some embodiments, the monitoring application 520 allows the user to change the sensitivity of each sensor 308, 312, 316 independently. In other embodiments, the monitoring application 520 allows the user to change the sensitivity of the security device 300 by changing the sensitivity of the sensors 308, 312, 316 simultaneously.

Various features and advantages of the invention are set forth in the following claims.

What is claimed is:

1. A security device for an electronic apparatus having a port, the security device comprising:
a housing;
a connector extending from the housing, the connector configured to couple to the port of the electronic apparatus;
a sensor supported by the housing, the sensor operable to generate an output in response to an event detected by the sensor; and
a wireless communication module supported by the housing and electrically coupled to the sensor, the wireless communication module operable to transmit a wireless message to a remote device based on the output from the sensor.

2. The security device of claim 1, further comprising an input port supported by the housing and coupled to the connector, wherein the input port allows data to pass through to the electronic apparatus.

3. The security device of claim 2, wherein the input port includes a universal serial bus port and the connector includes a universal serial bus connector.

4. The security device of claim 1, wherein the sensor includes an accelerometer that detects movement.

5. The security device of claim 1, wherein the sensor includes a light sensor that detects changes in ambient light.

6. The security device of claim 5, wherein the light sensor is also configured to receive configuration commands from an external device.

7. The security device of claim 1, wherein the sensor includes a voltage sensor that detects changes in power received from the electronic apparatus through the connector.

8. The security device of claim 1, wherein the sensor is a first sensor operable to generate a first output in response to movement of the security device, and further comprising:
a second sensor supported by the housing and operable to generate a second output in response to changes in ambient light conditions associated with the security device; and
a third sensor supported by the housing and operable to generate a third output in response to voltage changes through the connector.

9. The security device of claim 1, further comprising a power module coupled to the connector, the wireless communication module, and the processor, wherein the power module is configured to receive power from the electronic apparatus through the connector, and provide power to the wireless communication module.

10. The security device of claim 9, further comprising a battery supported by the housing and coupled to the wireless communication module, wherein the battery provides power to the wireless communication module when the security device is detached from the electronic apparatus.

11. The security device of claim 1, wherein the remote device includes a remote monitoring system, wherein the security device is configured to generate an alarm message based on the output from the sensor, and transmit the alarm message to the remote monitoring system, wherein the alarm message is used to associate the security device with a mobile communication device and to alert a user of the electronic apparatus through the mobile communication device.

12. The security device of claim 1, wherein the wireless communication module is configured to periodically transmit wireless messages to the remote device when the sensor does not detect the event.

13. The security device of claim 1, further comprising a processor supported by the housing and coupled to the sensor and the wireless communication module, wherein the processor is operable to determine whether the event was detected by the sensor, and control the wireless communication module to transmit the wireless message to the remote device when the event is detected by the sensor, and wherein the wireless message includes information regarding the event.

14. The security device of claim 13, wherein the wireless message includes identification information for the electronic apparatus.

15. The security device of claim 1, wherein the connector includes a universal serial bus connector.

16. A method of monitoring an electronic apparatus with a removable security device, the security device including a housing, a connector extending from the housing, a sensor supported by the housing, and a wireless communication module supported by the housing and electrically coupled to the sensor, the method comprising:
coupling the connector of the security device to a port of the electronic apparatus;
detecting, by the sensor, an event indicative of a state of the electronic apparatus;
generating, by the sensor, an output in response to the detected event; and
transmitting, by the wireless communication module, a wireless message to a remote device based on the output from the sensor.

17. The method of claim 16, wherein the security device also includes an input port supported by the housing and coupled to the connector, the method further comprising:
receiving a first communication from an external electronic device through the input port;
passing the first communication through to the electronic apparatus via the connector;
receiving a second communication from the electronic apparatus through the connector; and
passing the second communication through to the external electronic device via the input port.

18. The method of claim 16, wherein transmitting the wireless message includes transmitting an alarm message, the alarm message including information regarding the detected event.

19. The method of claim 16, wherein the sensor includes a light sensor, and wherein detecting the event includes detecting a change in ambient light.

20. The method of claim 16, wherein the sensor includes an accelerometer, and wherein detecting the event includes detecting a change in position of the security device.

21. The method of claim 16, further comprising receiving power from the electronic apparatus through the connector.

22. The method of claim 21, wherein the sensor includes a voltage sensor, and wherein detecting the event includes detecting a change in the power received by the electronic apparatus through the connector.
